(19) United States
(12) Patent Application Publication
(10) Pub. No.: US 2025/0389842 A1
(43) Pub. Date: Dec. 25, 2025

(54) SYSTEM AND METHOD FOR PHASE-BASED POSITIONING

(71) Applicant: Stichting IMEC Nederland, Eindhoven (NL)

(72) Inventor: Chris Marshall, Waalre (NL)

(21) Appl. No.: 19/245,242

(22) Filed: Jun. 20, 2025

(30) Foreign Application Priority Data
Jun. 25, 2024 (EP) 24184160.0

(51) Int. Cl. G01S 13/84; H04B 1/38

(52) U.S. Cl. CPC G01S 13/84; H04B 1/38

(57) ABSTRACT

A system for phase-based positioning is provided including at least one target device to transmit a first signal fragment, and at least one transceiver device to receive the first signal fragment from the target device, to measure a phase of the first signal fragment, and to transmit a second signal fragment with a phase having a known phase relationship with the measured phase of the first signal fragment. The system includes at least one receiver device to receive the first signal fragment from the target device, to measure the phase of the first signal fragment, to receive the second signal fragment from the transceiver device, and to measure the phase of the second signal fragment. The system includes at least one processing unit to calculate a phase difference between the phase of the first and second signal fragments to estimate position information of the target device.

### CROSS-REFERENCE TO RELATED APPLICATIONS

The present application is a non-provisional patent application claiming priority to European Patent Application No. 24184160.0, filed Jun. 25, 2024, the contents of which are hereby incorporated by reference.

### FIELD OF THE DISCLOSURE

The disclosure relates to a one-way localization scheme using phase measurements, such as phase difference of arrival measurements, of wireless signals.

### BACKGROUND

Generally, two-way localization systems are created for ranging, that use phase measurements of signals two devices, combined with the knowledge of the phase relationship between the transmission and reception of signals at each device.

On the other hand, one-way localization systems have uses, such as privacy (the information needed to estimate position is only available at one device), low latency (the information required for position estimation is readily and immediately available to a device using the information, for example, for navigation purposes) and scalability (multiple devices can be supported without linearly increasing the wireless capacity used).

For example, EP Patent No. 4 273 572 A1 discloses a one-way phase measurement system for estimating position information of a target node using a reference device and/or double-differencing techniques to remove the phase offsets of devices. However, the use of an additional reference node or device is cost intensive as well as resource intensive.

### SUMMARY

In view of the above, the disclosure provides systems and methods for phase-based positioning in a simplified and cost-effective manner. Also, the present disclosure removes the phase offsets of devices in a one-way localization scheme in a simplified and cost-effective manner.

The features of the present disclosure provides developments.

According to a first example embodiment of the disclosure, a system for phase-based positioning is provided. The system comprises at least one target device configured to transmit a first signal fragment. In addition, the system comprises at least one transceiver device configured to receive the first signal fragment from the target device, to measure a phase of the first signal fragment, and to transmit a second signal fragment with a phase having a known (e.g., predetermined) phase relationship with the measured phase of the first signal fragment.

Furthermore, the system comprises at least one receiver device configured to receive the first signal fragment from the target device, to measure the phase of the first signal fragment, to receive the second signal fragment from the transceiver device, and to measure the phase of the second signal fragment. Moreover, the system comprises at least one processing unit configured to calculate a phase difference between the phase of the first signal fragment as measured by the receiver device and the phase of the second signal fragment as measured by the receiver device to estimate position information of the target device.

In an example embodiment, the processing unit is configured to estimate the position information of the target device based on the calculated phase difference between the phase of the first signal fragment and the phase of the second signal fragment as measured by the receiver device and the known phase relationship between the phase of the second signal fragment and the measured phase of the first signal fragment.

Therefore, phase difference of arrival measurements are performed to locate the target device using a pair of anchors, i.e., the transceiver device and the receiver device, such as in an uplink configuration. Since a precise synchronization of the transceiver device and the receiver device is not used (e.g., required).

Further, a reference device is not used (e.g., required). Instead, the phase of the signal fragment transmitted by the transceiver device has a known phase relationship to the phase of the signal fragment received by the transceiver device, which may be sufficient to remove the phase offsets of devices.

The position information may relate to the relative position of the target device with respect to the position of the receiver device and/or the position of the transceiver device.

In an example embodiment, the position information of the transceiver device and the position information of the receiver device are known, such as to the processing unit. In other words, the transceiver device and the receiver device may act as anchors or anchor nodes, i.e., devices or nodes with predetermined locations and/or with precise geographical coordinates, for locating the target device.

For example, the first signal fragment transmitted by the target device comprises an arbitrary phase. Additionally or alternatively, the phase of the first signal fragment as measured by the transceiver device is arbitrary. For instance, the phase of the first signal fragment measured by the transceiver device relative to the local oscillator of the transceiver device may be arbitrary, since the phase of the local oscillator of the transceiver device is generally unknown.

In an example embodiment, the transceiver device is configured to transmit the known phase relationship between the phase of the second signal fragment and the measured phase of the first signal fragment to the processing unit. Alternatively, the known phase relationship between the phase of the second signal fragment and the measured phase of the first signal fragment is known a priori to the processing unit.

The transmission of the known phase relationship may cancel out the unknown arbitrary phase of the transceiver device. In other words, the known phase relationship between the phase of the reception of the first signal fragment and the phase of the transmission of the second signal fragment indicates (e.g., means) that the unknown phase offset of the transceiver oscillator/clock can be cancelled. Moreover, the measurement of the phase difference between the first signal fragment (i.e., the direct signal fragment from the target device to the receiver device) and the second signal fragment (i.e., the indirect signal fragment from the transceiver device to the receiver device) may cancel out the unknown phase offsets of the target device and of the receiver device, since the direct and the indirect signal fragments are derived from the same direct fragment phase.

In an example embodiment, the transceiver device is configured to transmit the second signal fragment at a different time with respect to a transmission time of the first signal fragment transmitted by the target device (e.g., to avoid collision). Additionally or alternatively, the transceiver device is configured to transmit the second signal fragment with a modulation scheme different from a modulation scheme of the first signal fragment transmitted by the target device (e.g., concurrent transmission with different spreading codes).

In an example embodiment, in both cases, the phase relationship between the phase of the second signal fragment and the measured phase of the first signal fragment is known. The direct and the indirect signal fragments are (e.g., easily) distinguishable at the receiver device.

In an example embodiment, the receiver device comprises the processing unit. The processing unit, e.g., by way of a positioning engine, may be (e.g., conveniently) implemented in the receiver device. Alternatively, the processing unit may be a remote processor, e.g., a processing function in the infrastructure, cloud, or other processing entity or service.

In an example embodiment, the transceiver device and the receiver device are access point devices, such as a wireless access point device. Additionally or alternatively, the transceiver device is a mobile device, such as a wireless mobile device. Additionally or alternatively, the target device is a mobile device, especially a wireless mobile device.

According to a second example embodiment of the disclosure, a further system for phase-based positioning is provided. The system comprises at least one transmitter device configured to transmit a first signal fragment. In addition, the system comprises at least one transceiver device configured to receive the first signal fragment from the transmitter device, to measure a phase of the first signal fragment, and to transmit a second signal fragment with a phase having a known phase relationship with the measured phase of the first signal fragment.

Furthermore, the system comprises at least one target device configured to receive the first signal fragment from the transmitter device, to measure the phase of the first signal fragment, to receive the second signal fragment from the transceiver device, and to measure the phase of the second signal fragment. Moreover, the system comprises at least one processing unit configured to calculate a phase difference between the phase of the first signal fragment as measured by the target device and the phase of the second signal fragment as measured by the target device to estimate position information of the target device.

In an example embodiment, the processing unit is configured to estimate the position information of the target device based on the calculated phase difference between the phase of the first signal fragment and the phase of the second signal fragment as measured by the target device and the known phase relationship between the phase of the second signal fragment and the measured phase of the first signal fragment.

Therefore, phase difference of arrival measurements are performed to locate the target device using a pair of anchors, i.e., the transmitter device and the transceiver device, especially in a downlink configuration, since a precise synchronization of the transceiver device and the receiver device may not be required.

Further, a reference device may not be required. Instead, the phase of the signal fragment transmitted by the transceiver device has a known phase relationship to the phase of the signal fragment received by the transceiver device, which may be sufficient to remove the phase offsets of devices.

The position information may relate to the relative position of the target device with respect to the position of the transmitter device and/or the position of the transceiver device.

In an example embodiment, the position information of the transmitter device and the position information of the transceiver device are known, such as to the processing unit. In other words, the transmitter device and the transceiver device may act as anchors or anchor nodes, i.e., devices or nodes with predetermined location(s) and/or with precise geographical coordinates, for locating the target device.

For example, the first signal fragment transmitted by the transmitter device comprises an arbitrary phase. Additionally or alternatively, the phase of the first signal fragment as measured by the transceiver device is arbitrary. For instance, the phase of the first signal fragment measured by the transceiver device relative to the local oscillator of the transceiver device may be arbitrary, since the phase of the local oscillator of the transceiver device is generally unknown.

In an example embodiment, the transceiver device is configured to transmit the known phase relationship between the phase of the second signal fragment and the measured phase of the first signal fragment to the processing unit. Alternatively, the known phase relationship between the phase of the second signal fragment and the measured phase of the first signal fragment is known a priori to the processing unit.

The transmission of the known phase relationship may cancel out the unknown arbitrary phase of the transceiver device. In other words, the known phase relationship between the phase of the reception of the first signal fragment and the phase of the transmission of the second signal fragment indicates (e.g., means) that the unknown phase offset of the transceiver oscillator/clock can be cancelled.

Moreover, the measurement of the phase difference between the first signal fragment (i.e., the direct signal fragment from the transmitter device to the target device) and the second signal fragment (i.e., the indirect signal fragment from the transceiver device to the target device) may cancel out the unknown phase offsets of the transmitter device and of the target device, since the direct and the indirect signal fragments are derived from the same direct fragment phase.

In an example embodiment, the transceiver device is configured to transmit the second signal fragment at a different time with respect to a transmission time of the first signal fragment transmitted by the transmitter device (e.g., to avoid collision). Additionally or alternatively, the transceiver device is configured to transmit the second signal fragment with a modulation scheme different from a modulation scheme of the first signal fragment transmitted by the transmitter device (e.g., concurrent transmission with different spreading codes).

In an example embodiment, in both cases, the phase relationship between the phase of the second signal fragment and the measured phase of the first signal fragment is known. The direct and the indirect signal fragments are (e.g., easily) distinguishable at the target device.

In an example embodiment, the target device comprises the processing unit. The processing unit, e.g., by way of a positioning engine, may be (e.g., conveniently) implemented in the target device. Alternatively, the processing unit may be a remote processor, e.g., a processing function in the infrastructure, cloud, or other processing entity or service.

In an example embodiment, the transmitter device and the transceiver device are access point devices, such as a wireless access point device. Additionally or alternatively, the transceiver device is a mobile device, such as a wireless mobile device. Additionally or alternatively, the target device is a mobile device, such as a wireless mobile device.

According to a third example embodiment of the disclosure, a method for phase-based positioning is provided. The method comprises a step of transmitting, by at least one target device, a first signal fragment. The method comprises a further step of receiving, by at least one transceiver device, the first signal fragment from the target device. The method comprises a further step of measuring, by the transceiver device, a phase of the first signal fragment. The method comprises a further step of transmitting, by the transceiver device, a second signal fragment with a phase having a known phase relationship with the measured phase of the first signal fragment.

The method comprises a further step of receiving, by at least one receiver device, the first signal fragment from the target device. The method comprises a further step of measuring, by the receiver device, the phase of the first signal fragment. The method comprises a further step of receiving, by the receiver device, the second signal fragment from the transceiver device. The method comprises a further step of measuring, by the receiver device, the phase of the second signal fragment.

The method comprises a further step of calculating, by at least one processing unit, a phase difference between the phase of the first signal fragment and the phase of the second signal fragment as measured by the receiver device. The method comprises a further step of estimating, by the processing unit, position information of the target device based on the calculated phase difference.

In an example embodiment, the method comprises a step of estimating the position information of the target device based on the calculated phase difference and the known phase relationship between the phase of the second signal fragment and the measured phase of the first signal fragment.

According to a fourth example embodiment of the disclosure, a further method for phase-based positioning is provided. The method comprises a step of transmitting, by at least one transmitter device, a first signal fragment. The method comprises a further step of receiving, by at least one transceiver device, the first signal fragment from the transmitter device. The method comprises a further step of measuring, by the transceiver device, a phase of the first signal fragment. The method comprises a further step of transmitting, by the transceiver device, a second signal fragment with a phase having a known phase relationship with the measured phase of the first signal fragment.

The method comprises a further step of receiving, by at least one target device, the first signal fragment from the transmitter device. The method comprises a further step of measuring, by the target device, the phase of the first signal fragment. The method comprises a further step of receiving, by the target device, the second signal fragment from the transceiver device. The method comprises a further step of measuring, by the target device, the phase of the second signal fragment.

The method comprises a further step of calculating, by at least one processing unit, a phase difference between the phase of the first signal fragment and the phase of the second signal fragment as measured by the target device. The method comprises a further step of estimating, by the processing unit, position information of the target device based on the calculated phase difference.

In an example embodiment, the method comprises a step of estimating the position information of the target device based on the calculated phase difference and the known phase relationship between the phase of the second signal fragment and the measured phase of the first signal fragment.

The terms “first,” “second,” etc. are used as labels for nouns that they precede, and do not imply any type of ordering or sequence of events, unless specifically stated.

A signal fragment may have a limited and/or a defined time-duration. For example, a signal fragment may be a discontinuous part of a wireless transmission sequence, e.g., TDMA wireless signals.

Position or location information may refer to a location in two-dimensional or three-dimensional space. In this regard, the position information can be a vertical comparative distance (for instance, which floor, which shelf) or a horizontal comparative distance (for example, proximity to boundary) and/or direction (for instance, collision path).

The method according to the third example embodiment corresponds to the system according to the first example embodiment and its implementation forms. Furthermore, the method according to the fourth example embodiment corresponds to the system according to the second example embodiment and its implementation forms.

The elements and/or components of the system according to the second example embodiment may have corresponding implementation forms of the analogous elements and/or components according to the system of the first example embodiment.

### BRIEF DESCRIPTION OF THE FIGURES

Example embodiments of the disclosure are now further explained with respect to the drawings and are illustrative and non-limiting. In the drawings:

FIG. 1 shows a first example embodiment of the system of the disclosure;

FIG. 2A shows an example phase differencing scheme according to the first example embodiment of the disclosure;

FIG. 2B shows an example message sequence chart according to the scheme of FIG. 2A;

FIG. 3 shows a second example embodiment of the system of the disclosure;

FIG. 4 shows an example phase differencing scheme according to the second example embodiment of the disclosure;

FIG. 5 shows a third example embodiment of the method of the disclosure; and

FIG. 6 shows a fourth example embodiment of the method of the disclosure.

The figures are schematic, not necessarily to scale, and generally show parts which elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Reference will now be made in detail to the embodiments of the present disclosure, examples of which are illustrated in the accompanying drawings. However, the following embodiments of the present disclosure may be variously modified, and the range of the present disclosure is not limited by the following embodiments.

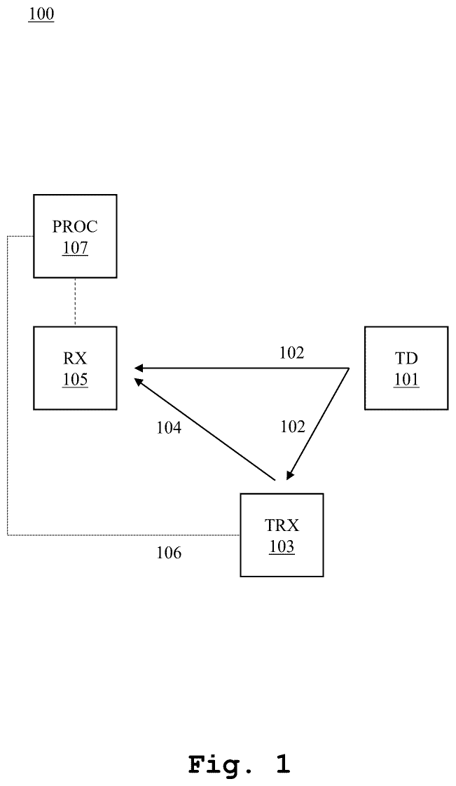

In FIG. 1, a (e.g., first) example embodiment of the system 100 is illustrated. The system 100 may comprise a target device or a user device 101, which may transmit a first signal fragment 102, for instance, with an arbitrary phase. The system 100 may further comprise a transceiver device or a transceiver 103, which may receive the first signal fragment 102 from the target device 101.

In this regard, the transceiver device 103 may measure a phase of the first signal fragment 102, where the measured phase of the first signal fragment 102 received from the target device 101 may be arbitrary, such as relative to the local oscillator of the transceiver device 103, since the phase of the local oscillator of the transceiver device 103 is generally unknown.

The transceiver device 103 may transmit a second signal fragment 104 with a phase having a known phase relationship with the measured phase of the first signal fragment 102. In other words, the transceiver device 103 may transmit the second signal fragment 104 with a known phase relationship between the phase of the measured first signal fragment 102 received from the target device 101 and the phase of the transmitted second signal fragment 104. This may (e.g., effectively) cancel out the unknown arbitrary phase of the transceiver device 103.

For example, the transceiver device 103 may take into account any additional phase shift factors, such as phase shifts during the signal passing through the amplifier(s), mixer(s), filter(s), signal converter(s), and so on, of the transceiver device 103, in the above-mentioned phase relationship.

The system 100 may further comprise a receiver device or a receiver 105, which may receive the first signal fragment 102 from the target device 101 and may measure the phase of the first signal fragment 102. In addition, the receiver device 105 may further receive the second signal fragment 104 from the transceiver device 103 and may measure the phase of the second signal fragment 104.

The system 100 may further comprise a processing unit or a processor 107. The processing unit 107 may comprise one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or the like. The processing unit 107 may be implemented in the receiver device 105.

The processing unit 107 may calculate a phase difference between the phase of the first signal fragment 102 and the phase of the second signal fragment 104 as measured by the receiver device 105 to estimate location information of the target device 101. Since the first signal fragment 102 and the second signal fragment 104 are derived from the same phase of the first signal fragment 102, this may cancel out the unknown phase offsets of the target device 101 and of the receiver device 105.

For example, the difference in phase between the phase of the first signal fragment 102 and the phase of the second signal fragment 104 as measured by the receiver device 105 may provide location information of the target device 101 as the difference in propagation distance plus the phase change introduced within the transceiver device 103 between the reception and transmission. Since the phase between transmission and reception is known, for instance, the local oscillator phase of the transceiver device 103 has no effect, and thus the value of the (e.g., said) phase between transmission and reception can (e.g., effectively) determine the locus for the location of the target.

In this regard, the processing unit 107 may have prior knowledge regarding the location information of the transceiver device 103 and the location information of the receiver device 105. As such, the distance and the propagation time between the transceiver device 103 and the receiver device 105 may be known to the processing unit 107.

Hence, the difference in phase between the phase of the first signal fragment 102 and the phase of the second signal fragment 104 as measured by the receiver device 105 may provide location information of the target device 101 as, for example, a hyperbola or a family of hyperbolae (e.g., due to the phase measurement ambiguity of 2π) for the locus of positions for the target device 101.

For instance, the processing unit 107 may have prior knowledge regarding the known phase relationship or the relative phase between the phase of the second signal fragment 104 and the measured phase of the first signal fragment 102, i.e., the transceiver phase relationship.

For example, the processing unit 107 may calibrate the above-mentioned phase relationship information by using (e.g., means of) previous measurements. For instance, with measurements when the target device 101 is in a known location, the phase relationship information of the transceiver device 103 can be estimated (such that the estimated location of the target device 101 corresponds to the actual known location) and the (e.g., said) estimated value can be used by the processing unit 107 for finding the location in further unknown locations of the target device 101.

For example, the relative phase or the transceiver phase relationship may be known a priori by design, e.g., that the local oscillator in the transceiver device 103 may be aligned with the first signal fragment 102 from the target device 101, and may be used directly to generate the second signal fragment 104 transmitted by the transceiver device 103.

Alternatively, the relative phase or the transceiver phase relationship may be known a posteriori by measurement, e.g., the transceiver device 103 may measure the phase of the first signal fragment 102 received from the target device 101, may further measure the phase of the second signal fragment 104, and may report, e.g., via a communication link 106, the phase difference to the processing unit 107.

For example, the information on the value of the relative phase or the transceiver phase relationship may be provided as assistance information, e.g., as configuration information. Additionally or alternatively, the information on the value of the relative phase or the transceiver phase relationship may be provided as data contained in the second signal fragment 104 transmitted by the transceiver device 103.

For example, the relative phase between the second signal fragment 104 transmitted by the transceiver device 103 and the first signal fragment 102 received by the transceiver device 103 may be in the range interval −π to +π or equivalently from zero to 2π, i.e., the relative phase or the transceiver phase relationship may be positive or negative.

For example, regarding the relative phase between the second signal fragment 104 transmitted by the transceiver device 103 and the first signal fragment 102 received by the transceiver device 103, a phase difference of zero can be (e.g., very) useful such that the second signal fragment 104 is in perfect phase with the measured phase of the first signal fragment 102, and therefore the processing unit 107 may (e.g., already) assume the relative phase or the transceiver phase relationship without the prior or posterior knowledge. This can be achieved, for example, by transmitting the second signal fragment 104 by the transceiver device 103 with the same phase or with multiples of 2π as that of the first signal fragment 102 received by the transceiver device 103.

For example, the transceiver device 103 may transmit the second signal fragment 104 at a different time with respect to a transmission time of the first signal fragment 102 transmitted by the target device 101, e.g., to avoid collision.

Alternatively, the transceiver device 103 may transmit the second signal fragment 104 with a modulation scheme different from a modulation scheme, e.g., a different spreading code, of the first signal fragment 102 transmitted by the target device 101. In this regard, the transceiver device 103 may transmit the second signal fragment 104 concurrently with the transmission of the first signal fragment 102 transmitted by the target device 101.

For example, the second signal fragment 104 transmitted by the transceiver device 103 may be transmitted close in time to the first signal fragment 102 transmitted by the target device 101. This may be useful since in practice there may be a small frequency offset between the local oscillator in the transceiver device 103 and the local oscillator in the receiver device 105, and this small frequency offset may give rise to a difference in phase changes as perceived by these two devices.

As such, this may have an impact (e.g., effect) on the receiver device 105 depending on the elapsed time between the reception of the first signal fragment 102 from the target device 101 and the second signal fragment 104 from the transceiver device 103. For example, the transceiver device 103 may transmit the second signal fragment 104 in advance or following the reception of the first signal fragment 102 from the target device 101, and may report the resulting phase relationship to the processing unit 107.

In this regard, for example, the transceiver device 103 may recently have transmitted a signal or a signal fragment, and then receives the first signal fragment 102, and may measure the phase of arrival of the currently received signal, i.e., the first signal fragment 102, compare it to the phase of the signal or the signal fragment it recently transmitted, and communicate the difference to the processing unit 107.

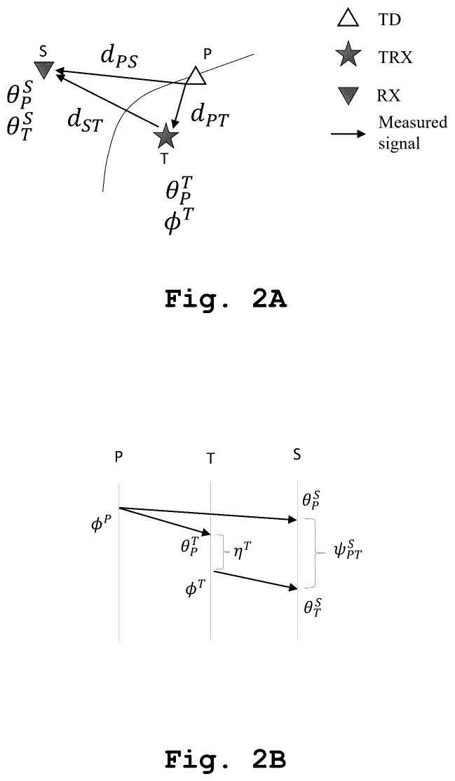

In FIG. 2A and FIG. 2B, an example one-way positioning scheme is illustrated, such as for the uplink configuration of the target device 101. For example, FIG. 2A shows the measurement of the phase difference of arrival, and FIG. 2B shows the corresponding message sequence chart.

The symbol P denotes the target device 101, the symbol T denotes the transceiver device 103, and the symbol S denoted the receiver device 105. The directional arrows denote the received and measured signals. For instance, d_{PT} denotes the propagation distance between the target device P and the transceiver device T, d_{ST} denotes the propagation distance between the receiver device S and the transceiver device T, and d_{PS} denotes the propagation distance between the target device P and the receiver device S.

In the following mathematical description, the phase of the signal fragment transmitted by X is indicated by ϕ^{X} and the phase of the signal from Y as received and measured by X is indicated by

$${θ}_{Y}^{X} .$$

All phases are with respect to the local oscillator of the device, are in the range −π to +π, and subject to an arbitrary wrap-around ambiguity of 2π, giving rise to an unknown ambiguity indicated by the integer k, which may take a different value in each line of the equations.

The target device P, the transceiver device T, and the receiver device S have local oscillators at the same frequency, but with arbitrary and unknown phases α^{P}, α^{T} and α^{S}, respectively.

The signal fragment from the target device P is transmitted with phase ϕ^{T} relative to its local oscillator and measured (e.g., directly) by the receiver device S with observed phase corresponding to the propagation distance, and the difference between the phases of the local oscillators of the target device P and the receiver device S.

$${θ}_{P}^{S} = 2 π \frac{{d}_{PS}}{λ} + {ϕ}^{P} + {α}^{P} - {α}^{S} + k 2 π \qquad ( 1 )$$

Similarly, this signal fragment is received and measured by the transceiver device T with observed phase

$${θ}_{P}^{T} = 2 π \frac{{d}_{PT}}{λ} + {ϕ}^{P} + {α}^{P} - {α}^{T} + k 2 π \qquad ( 2 )$$

The transceiver device T then transmits a signal fragment with known phase relationship η^{T} of the transmitted signal fragment compared to the measured phase of the received signal fragment

$${ϕ}^{T} = {θ}_{P}^{T} + {η}^{T} + k 2 π \qquad ( 3 )$$

so that the phase of the fragment transmitted by the transceiver device T as measured by its local oscillator is

$${ϕ}^{T} = 2 π \frac{{d}_{PT}}{λ} + {η}^{T} + {ϕ}^{P} + {α}^{P} - {α}^{T} + k 2 π \qquad ( 4 )$$

This signal is then received and measured by the receiver device S with phase relative to its local oscillator, again corresponding to the propagation distance and the difference between the phases of the local oscillators:

$${θ}_{T}^{S} = 2 π \frac{{d}_{ST}}{λ} + {ϕ}^{T} + {α}^{T} - {α}^{S} + k 2 π \qquad ( 5 )$$

So, substituting for the phase of the signal fragment transmitted by the transceiver device T

$${θ}_{T}^{S} = 2 π \frac{{d}_{S T} + {d}_{P T}}{λ} + {η}^{T} + {ϕ}^{P} + {α}^{P} - {α}^{S} + k 2 π \qquad ( 6 )$$

From which it can be seen that the unknown phase offset of the transceiver device α^{T} has dropped out, since the relative phase between the reception and transmission η^{T}, i.e., the transceiver phase relationship is (e.g., all that is) relevant.

The receiver device S, such as the processing unit 107, then compares the phase of the direct signal fragment received from the target device P

$${θ}_{P}^{S}$$

and the indirect signal fragment received from the transceiver device T

$${θ}_{T}^{S} , ( {θ}_{P}^{S} - {θ}_{T}^{S} ) ,$$

which is given by

$${θ}_{P}^{S} - {θ}_{T}^{S} = 2 π \frac{{d}_{P S} - {d}_{P T} - {d}_{S T}}{λ} - {η}^{T} + k 2 π \qquad ( 7 )$$

As it can be seen, the unknown phase offset terms α^{P} and α^{S} have been cancelled out.

Writing the phase difference between the signal fragments from the target device P and the transceiver device T as measured by the receiver device S as:

$${ψ}_{P T}^{S} = {θ}_{P}^{S} - {θ}_{T}^{S} \qquad ( 8 )$$

and rearranging this expression then gives the information on the difference in distance between the target device P and the two anchors, namely the transceiver device T and the receiver device S, which since the locations of the anchors (and hence also the distance between them, d_{ST}), gives the locus of possible locations for the target device P on the hyperbola with foci T and S, according to

$$( {d}_{P S} - {d}_{P T} ) = \frac{λ}{2 π} [ {ψ}_{P T}^{S} + {η}^{T} ] + {d}_{S T} + k λ \qquad ( 9 )$$

The location information is thus provided by the phase difference measurement of the fragments at the receiver device S, combined with the known phase between transmission of the fragment and the reception of the fragment by the transceiver device T. This is independent of the phase offsets of the individual devices. The (e.g., particular) hyperbolic locus may be (e.g., is) ambiguous, according to the wavelength λ of the phase difference.

For example, the measurements of the uplink configuration according to the system 100 can be performed at multiple frequencies.

When measurements are made at multiple frequencies, the difference in phase as measured by the receiver can be defined at frequency fᵢ with wavelength λᵢ as

$${ψ}_{i} = {ψ}_{P T}^{S} = {θ}_{S}^{P} - {θ}_{T}^{P} ,$$

dropping the sur- and suffixes of ψ.

As such, the difference between phase measurements at two frequencies can be formed (assuming for simplicity that η^{T} is (substantially) constant by design), then it can be shown that the phase difference observed at the difference frequency corresponds to the spatial variation at the wavelength corresponding to that difference frequency, so that with

$${ψ}_{i j} = {ψ}_{i} - {ψ}_{j} \qquad ( 10 )$$

$$( {d}_{P S} - {d}_{P T} ) = \frac{{λ}_{i j}}{2 π} [ {ψ}_{ij} + {η}^{T} ] + {d}_{S T} + k {λ}_{ij} \qquad ( 11 )$$

$$Where$$

$${λ}_{i j} = \frac{c}{{f}_{i} - {f}_{j}} \qquad ( 12 )$$

The location information using the difference between the phase at a pair of frequencies then corresponds to the same hyperbolic variation with foci at the anchors S and T, but now with the precision and ambiguity of which hyperbola corresponds to the wavelength for the difference between the frequencies. Close frequencies give a long wavelength and large ambiguity distance, while widely spaced frequencies give a shorter wavelength, better precision, and short ambiguity distance.

In addition to the above-described phase difference of arrival measurement, the system 100 may additionally perform one or more time difference of arrival measurements, e.g., between the target device P and the receiver device S, and may combine the time difference of arrival measurements with the above-described phase difference of arrival measurement in order to resolve any ambiguity in the phase difference of arrival measurements.

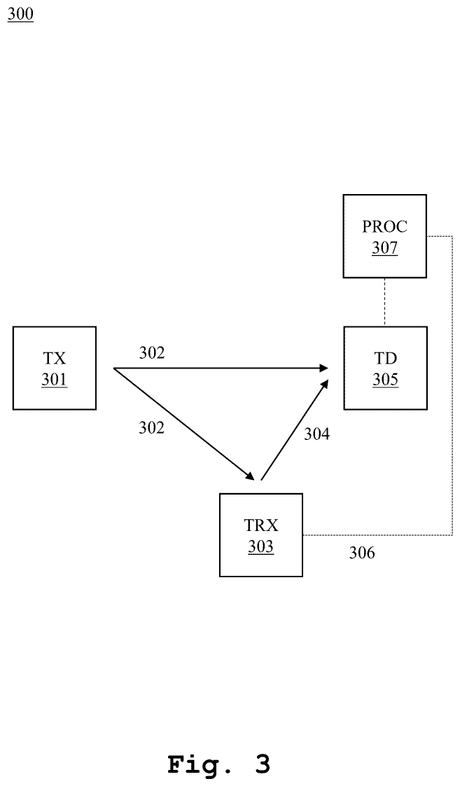

In FIG. 3, a second example embodiment of the system 300 is illustrated. The system 300 may comprise a transmitter device or a transmitter 301, which may transmit a first signal fragment 302, for instance, with an arbitrary phase. The system 300 may further comprise a transceiver device or a transceiver 303, which may receive the first signal fragment 302 from the transmitter device 301.

In this regard, the transceiver device 303 may measure a phase of the first signal fragment 302, where the phase of the measured first signal fragment 302 received from the transmitter device 301 may be arbitrary, such as relative to the local oscillator of the transceiver device 303, since the phase of the local oscillator of the transceiver device 303 is generally unknown.

The transceiver device 303 may transmit a second signal fragment 304 with a phase having a known phase relationship with the measured phase of the first signal fragment 302. In other words, the transceiver device 303 may transmit the second signal fragment 304 with a known phase relationship between the phase of the measured first signal fragment 302 received from the transmitter device 301 and the phase of the transmitted second signal fragment 304. This may (e.g., effectively) cancel out the unknown arbitrary phase of the transceiver device 303.

In an example embodiment, the transceiver device 303 may take into account any additional phase shift factors, such as phase shifts during the signal passing through the amplifier(s), mixer(s), filter(s), signal converter(s), and so on, of the transceiver device 303, in the above-mentioned phase relationship.

The system 300 may further comprise a target device or a user device 305, which may receive the first signal fragment 302 from the transmitter device 301 and may measure the phase of the first signal fragment 302. In addition, the target device 305 may further receive the second signal fragment 304 from the transceiver device 303 and may measure the phase of the second signal fragment 304.

The system 300 may further comprise a processing unit or a processor 307. The processing unit 307 may comprise one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or the like. The processing unit 307 may be implemented in the target device 305.

The processing unit 307 may calculate a phase difference between the phase of the first signal fragment 302 and the phase of the second signal fragment 304 as measured by the target device 305 to estimate location information of the target device 305. Since the first signal fragment 302 and the second signal fragment 304 are derived from the same phase of the first signal fragment 302, this may cancel out the unknown phase offsets of the transmitter device 301 and of the target device 305.

For example, the difference in phase between the phase of the first signal fragment 302 and the phase of the second signal fragment 304 as measured by the target device 305 may provide location information of the target device 305 as the difference in propagation distance plus the phase change introduced within the transceiver device 303 between the reception and transmission. Since the phase introduced within the transceiver device between transmission and reception is known, for instance, the local oscillator phase of the transceiver device 303 has no effect, and thus the value of the (e.g., said) phase between transmission and reception can effectively determine the locus for the location of the target.

In this regard, the processing unit 307 may have prior knowledge regarding the location information of the transceiver device 303 and the location information of the transmitter device 301. As such, the distance and the propagation time between the transmitter device 301 and the transceiver device 303 may be known to the processing unit 307.

Hence, the difference in phase between the phase of the first signal fragment 302 and the phase of the second signal fragment 304 as measured by the target device 305 may provide location information of the target device 305 as, for example, a hyperbola or a family of hyperbolae (e.g., due to the phase measurement ambiguity of 2π) for the locus of positions for the target device 305.

For instance, the processing unit 307 may have prior knowledge regarding the known phase relationship or the relative phase between the phase of the second signal fragment 304 and the measured phase of the first signal fragment 302, i.e., regarding the transceiver phase relationship.

For example, the processing unit 307 may calibrate the above-mentioned phase relationship information, i.e., the transceiver phase relationship by using (e.g., means of) previous measurements. For instance, with measurements when the target device 305 is in a known location, the phase relationship information of the transceiver device 303 can be estimated (such that the estimated location of the target device 305 corresponds to the actual known location) and the (e.g., said) estimated value can be used by the processing unit 307 for finding the location in further unknown locations of the target device 305.

For example, the relative phase or the transceiver phase relationship may be known a priori by design, e.g., that the local oscillator in the transceiver device 303 may be aligned with the first signal fragment 302 from the transmitter device 301, and may be used (e.g., directly) to generate the second signal fragment 304 transmitted by the transceiver device 303.

Alternatively, the relative phase or the transceiver phase relationship may be known a posteriori by measurement, e.g., the transceiver device 303 may measure the phase of the first signal fragment 302 received from the transmitter device 301, may further measure the phase of the second signal fragment 304, and may report, e.g., via a communication link 306, the phase difference to the processing unit 307.

For example, the information on the value of the relative phase or the transceiver phase relationship may be provided as assistance information, e.g., as configuration information. Additionally or alternatively, the information on the value of the relative phase or the transceiver phase relationship may be provided as data contained in the second signal fragment 304 transmitted by the transceiver device 303.

For example, the relative phase between the second signal fragment 304 transmitted by the transceiver device 303 and the first signal fragment 302 received by the transceiver device 303 may be in the range interval −πto +π or equivalently from zero to 2π, i.e., the relative phase or the transceiver phase relationship may be positive or negative.

For example, regarding the relative phase between the second signal fragment 304 transmitted by the transceiver device 303 and the first signal fragment 302 received by the transceiver device 303, a phase difference of zero can be (e.g., very) useful such that the second signal fragment 304 is in perfect phase with the measured phase of the first signal fragment 302, and therefore the processing unit 307 can already assume the relative phase or the transceiver phase relationship without the prior or posterior knowledge. This can be achieved, for example, by producing the second signal fragment 304 by the transceiver device 303 with the same phase or with multiples of 2π as that of the first signal fragment 302 received by the transceiver device 303.

For example, the transceiver device 303 may transmit the second signal fragment 304 at a different time with respect to a transmission time of the first signal fragment 302 transmitted by the transmitter device 301, e.g., to avoid collision.

Alternatively, the transceiver device 303 may transmit the second signal fragment 304 with a modulation scheme different from a modulation scheme, e.g., a different spreading code, of the first signal fragment 302 transmitted by the transmitter device 301. In this regard, the transceiver device 303 may transmit the second signal fragment 304 concurrently with the transmission of the first signal fragment 302 transmitted by the transmitter device 301.

For example, the second signal fragment 304 transmitted by the transceiver device 303 may be transmitted close in time to the first signal fragment 302 transmitted by the transmitter device 301. This may be useful since in practice there may be a small frequency offset between the local oscillator in the transceiver device 303 and the local oscillator in the target device 305, and this small frequency offset may give rise to a difference in phase changes as perceived by these two devices.

As such, this may have an impact (e.g., effect) on the target device 305 depending on the elapsed time between the reception of the first signal fragment 302 from the transmitter device 301 and the second signal fragment 304 from the transceiver device 303. For example, the transceiver device 303 may transmit the second signal fragment 304 in advance or following the reception of the first signal fragment 302 from the transmitter device 301, and may report the resulting phase relationship to the processing unit 307.

In this regard, for example, the transceiver device 303 may recently have transmitted a signal or a signal fragment, and then receives the first signal fragment 302, and may measure the phase of arrival of the currently received signal, i.e., the first signal fragment 302, compare it to the phase of the signal or the signal fragment it recently transmitted, and communicate the difference, i.e., the transceiver phase relationship to the processing unit 307.

The target device 305, the transceiver device 303, the transmitter device 301, and the processing unit 307 of the system 300 may correspond to the target device 101, the transceiver device 103, the receiver device 105 (e.g., as a further transceiver device), and the processing unit 107 of the system 100, respectively. Therefore, the system 100 corresponds to an uplink configuration for the target device 101, and the system 300 corresponds to a downlink configuration for the target device 305.

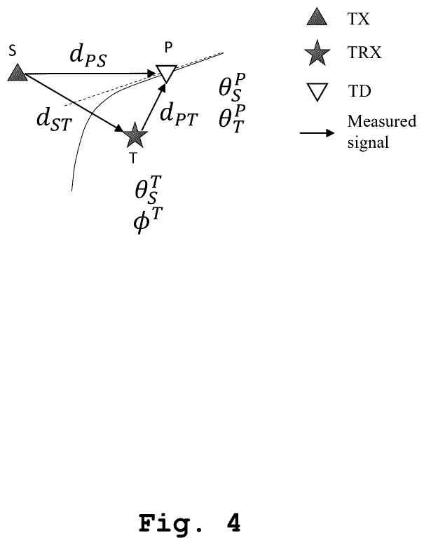

In FIG. 4, an example one-way positioning scheme is illustrated, such as for the downlink configuration of the target device 305.

Analogous to the positioning scheme of FIG. 2A, the symbol P denotes the target device 305, the symbol T denotes the transceiver device 303, and the symbol S denoted the transmitter device 301. The directional arrows denote the received and measured signals. For instance, d_{PT} denotes the propagation distance between the target device P and the transceiver device T, d_{ST} denotes the propagation distance between the transmitter device S and the transceiver device T, and d_{PS} denotes the propagation distance between the target device P and the transmitter device S.

Analogous to the positioning scheme of FIG. 2A, the phase of the signal fragment transmitted by X is indicated by ϕ^{X} and the phase of the signal from Y as received and measured by X is indicated by

$${θ}_{Y}^{X} .$$

Analogous to the positioning scheme of FIG. 2A, (e.g., all) phases are with respect to the local oscillator of the device, are in the range −π to +π, and subject to an arbitrary wrap-around ambiguity of 2π, giving rise to an unknown ambiguity indicated by the integer k.

Analogous to the positioning scheme of FIG. 2A, the target device P, the transceiver device T, and the transmitter device S have local oscillators at the same frequency, but with arbitrary and unknown phases α^{P}, α^{T} and α^{S}, respectively.

Analogously, the equation (3) can be derived for the downlink configuration of the target device P as:

$$( {ϕ}^{T} - {θ}_{S}^{T} ) = {η}^{T} + 2 π k \qquad ( 13 )$$

In the downlink configuration the measured phase difference is that as measured by the receiver device P between the first signal fragment from the transmitter device S and the second signal fragment from the transceiver device T

$${ψ}_{ST}^{P} = {θ}_{S}^{P} - {θ}_{T}^{P} \qquad ( 14 )$$

Analogously then, the equation (9) can be derived for the downlink configuration of the target device P as:

$$( {d}_{P S} - {d}_{P T} ) = \frac{λ}{2 π} [ {ψ}_{S T}^{P} + {η}^{T} ] + {d}_{S T} \qquad ( 15 )$$

In a manner analogous to the positioning scheme of FIG. 2A, it can be seen that the unknown phase offset terms α^{T}, α^{P} and α^{S} have dropped out, and the relative phase between the reception and transmission nη^{T}, i.e., the transceiver phase relationship is (e.g., all that is) relevant.

Analogous to the uplink configuration according to the system 100, the measurements of the downlink configuration according to the system 300 can be performed at multiple frequencies.

Analogous to the uplink configuration according to the system 100, the system 300 may additionally perform one or more time difference of arrival measurements, e.g., between the target device P and the transmitter device S, and may combine the time difference of arrival measurements with the above-described phase difference of arrival measurement in order to resolve any ambiguity in the phase difference of arrival measurements.

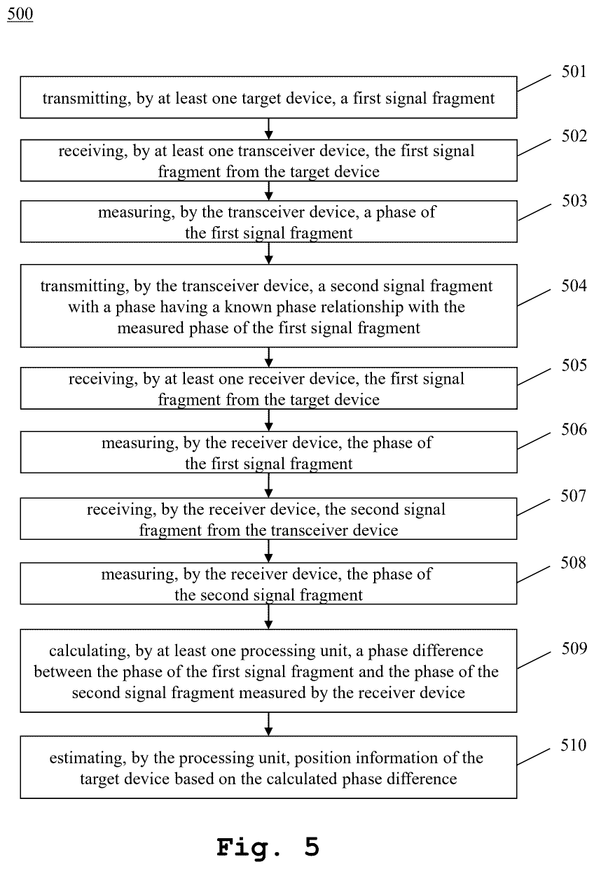

In FIG. 5, a third example embodiment of the method 500 is illustrated. In a first step 501, a first signal fragment is transmitted by at least one target device. In a second step 502, the first signal fragment from the target device is received by at least one transceiver device. In a third step 503, a phase of the first signal fragment is measured by the transceiver device. In a fourth step 504, a second signal fragment with a phase having a known phase relationship with the measured phase of the first signal fragment is transmitted by the transceiver device.

In a fifth step 505, the first signal fragment from the target device is received by at least one receiver device. In a sixth step 506, the phase of the first signal fragment is measured by the receiver device. In a seventh step 507, the second signal fragment from the transceiver device is received by the receiver device. In an eighth step 508, the phase of the second signal fragment is measured by the receiver device.

In a ninth step 509, a phase difference between the phase of the first signal fragment and the phase of the second signal fragment as measured by the receiver device is calculated by at least one processing unit. In a tenth step 510, position information of the target device are estimated by the processing unit based on the calculated phase difference.

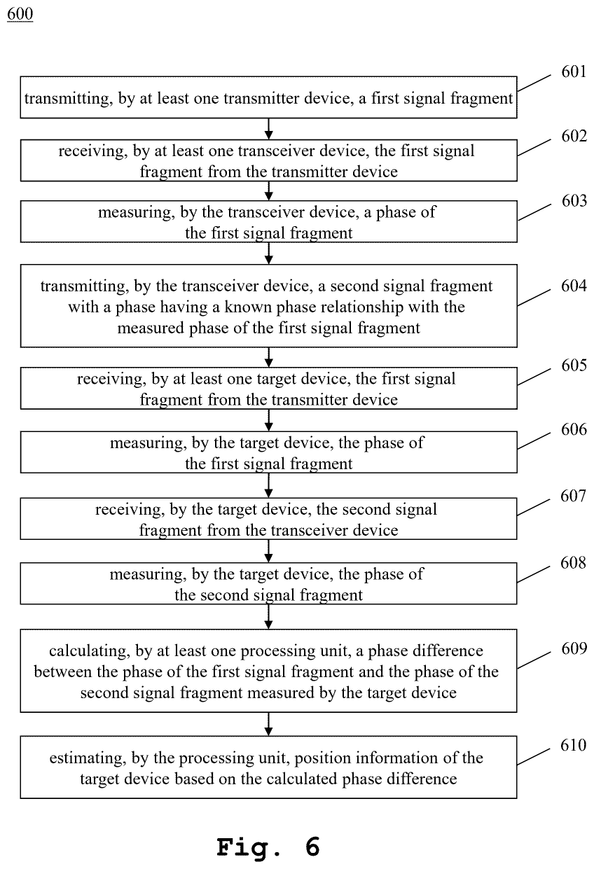

In FIG. 6, a fourth example embodiment of the method 600 is illustrated. In a first step 601, a first signal fragment is transmitted by at least one transmitter device. In a second step 602, the first signal fragment from the transmitter device is received by at least one transceiver device. In a third step 603, a phase of the first signal fragment is measured by the transceiver device. In a fourth step 604, a second signal fragment with a phase having a known phase relationship with the measured phase of the first signal fragment is transmitted by the transceiver device.

In a fifth step 605, the first signal fragment from the transmitter device is received by at least one target device. In a sixth step 606, the phase of the first signal fragment is measured by the target device. In a seventh step 607, the second signal fragment from the transceiver device is received by the target device. In an eighth step 608, the phase of the second signal fragment is measured by the target device.

In a ninth step 609, a phase difference between the phase of the first signal fragment and the phase of the second signal fragment as measured by the target device is calculated by at least one processing unit. In a tenth step 610, position information of the target device are estimated by the processing unit based on the calculated phase difference.

Therefore, the disclosure involves a one-way localization system (e.g., with associated improvements and/or benefits) for the localization of transmit-only tags by a system (e.g., for asset management in a warehouse), and for the private and low-latency measurement of broadcast wireless signals for devices to position themselves by receive-only measurements (e.g., in an autonomous guided vehicle).

Furthermore, the disclosure addresses high precision localization using phase measurements, such as for the precise relative position between devices (e.g., for collision-avoidance, or for tool-workpiece alignment).

For example, since one of the two (close in time) devices can be a transceiver and the other a target, this disclosure can be used to (e.g., precisely) locate the target relative to the transceiver. The estimate is not much affected by errors in the knowledge of the absolute location of the (close) transceiver or of the (somewhat distant) anchor, since it is the relative position of the target with respect to the (close) transceiver which is estimated.

Moreover, the disclosure addresses the cost of wireless positioning, such as for large-scale IoT applications, such that devices with (e.g., only) loose synchronization aspects (e.g., requirements) can be used (i.e., sufficient for general network management, but not for actual phase synchronization between devices), thereby allowing low cost oscillator components, as well as avoiding expensive installation, cabling and maintenance for synchronization. In addition, the disclosure facilitates an indirect phase differencing scheme that circumvents using an additional separate reference device.

In the description as well as in the claims, the word “comprising” does not exclude other elements or steps and the indefinite article “a” or “an” does not exclude a plurality. A single element or other unit may fulfill the functions of several entities or items recited in the claims.

The term “and/or” used in the specification and the appended claims of this application refers to any combination and possible combinations of one or more associated listed items, and includes these combinations.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to one of several implementations, such feature may be combined with one or more other features of the other implementations as may be useful for any given or particular application.

What is claimed is:

1. A system for phase-based positioning comprising:
at least one target device configured to transmit a first signal fragment,
at least one transceiver device configured to receive the first signal fragment from the target device, to measure a phase of the first signal fragment, and to transmit a second signal fragment with a phase having a predetermined phase relationship with the measured phase of the first signal fragment,
at least one receiver device configured to receive the first signal fragment from the target device, to measure the phase of the first signal fragment, to receive the second signal fragment from the transceiver device, and to measure the phase of the second signal fragment, and
at least one processing unit configured to calculate a phase difference between the phase of the first signal fragment and the phase of the second signal fragment as measured by the receiver device to estimate position information of the target device.

2. The system according to claim 1,
wherein the processing unit is configured to estimate the position information of the target device based on the calculated phase difference between the phase of the first signal fragment and the phase of the second signal fragment as measured by the receiver device and the predetermined phase relationship between the phase of the second signal fragment and the measured phase of the first signal fragment.

3. The system according to claim 1,
wherein the position information of the transceiver device and the position information of the receiver device are provided to the processing unit.

4. The system according to claim 1,
wherein the first signal fragment transmitted by the target device comprises an arbitrary phase.

5. The system according to claim 1,
wherein the phase of the first signal fragment as measured by the transceiver device is arbitrary.

6. The system according to claim 1,
wherein the transceiver device is configured to transmit the predetermined phase relationship between the phase of the second signal fragment and the measured phase of the first signal fragment to the processing unit.

7. The system according to claim 1,
wherein the predetermined phase relationship between the phase of the second signal fragment and the measured phase of the first signal fragment is a priori to the processing unit.

8. The system according to claim 1,
wherein the transceiver device is configured to transmit the second signal fragment at a different time with respect to a transmission time of the first signal fragment transmitted by the target device, or
wherein the transceiver device is configured to transmit the second signal fragment with a modulation scheme different from a modulation scheme of the first signal fragment transmitted by the target device.

9. The system according to claim 1,
wherein the receiver device comprises the processing unit.

10. The system according to claim 1,
wherein the transceiver device and the receiver device are access point devices, and wherein the access point devices are wireless access point devices.

11. The system according to claim 1,
wherein the transceiver device is a mobile device, and wherein the mobile device is a wireless mobile device.

12. The system according to claim 1,
wherein the target device is a mobile device, and wherein the mobile device is a wireless mobile device.

13. A system for phase-based positioning comprising:
at least one transmitter device configured to transmit a first signal fragment,
at least one transceiver device configured to receive the first signal fragment from the transmitter device, to measure a phase of the first signal fragment, and to transmit a second signal fragment with a phase having a predetermined phase relationship with the measured phase of the first signal fragment,
at least one target device configured to receive the first signal fragment from the transmitter device, to measure the phase of the first signal fragment, to receive the second signal fragment from the transceiver device, and to measure the phase of the second signal fragment, and
at least one processing unit configured to calculate a phase difference between the phase of the first signal fragment and the phase of the second signal fragment as measured by the target device to estimate position information of the target device.

14. The system according to claim 13,
wherein the processing unit is configured to estimate the position information of the target device based on the calculated phase difference between the phase of the first signal fragment and the phase of the second signal fragment as measured by the target device and the predetermined phase relationship between the phase of the second signal fragment and the measured phase of the first signal fragment.

15. The system according to claim 13,
wherein the position information of the transmitter device and the position information of the transceiver device are provided to the processing unit.

16. The system according to claim 13,
wherein the first signal fragment transmitted by the transmitter device comprises an arbitrary phase, or
wherein the phase of the first signal fragment as measured by the transceiver device is arbitrary.

17. The system according to claim 13,
wherein the transceiver device is configured to transmit the predetermined phase relationship between the phase of the second signal fragment and the measured phase of the first signal fragment to the processing unit, or
wherein the predetermined phase relationship between the phase of the second signal fragment and the measured phase of the first signal fragment is a priori to the processing unit, or wherein the target device comprises the processing unit.

18. The system according to claim 13,
wherein the transceiver device is configured to transmit the second signal fragment at a different time with respect to a transmission time of the first signal fragment transmitted by the transmitter device or
wherein the transceiver device is configured to transmit the second signal fragment with a modulation scheme different from a modulation scheme of the first signal fragment transmitted by the transmitter device.

19. A method for phase-based positioning comprising:
transmitting, by at least one target device, a first signal fragment,
receiving, by at least one transceiver device, the first signal fragment from the target device,
measuring, by the transceiver device, a phase of the first signal fragment,
transmitting, by the transceiver device, a second signal fragment with a phase having a phase relationship with the measured phase of the first signal fragment,
receiving, by at least one receiver device, the first signal fragment from the target device,
measuring, by the receiver device, the phase of the first signal fragment,
receiving, by the receiver device, the second signal fragment from the transceiver device,
measuring, by the receiver device, the phase of the second signal fragment,
calculating, by at least one processing unit, a phase difference between the phase of the first signal fragment and the phase of the second signal fragment as measured by the receiver device, and
estimating, by the processing unit, position information of the target device based on the calculated phase difference.

20. A method for phase-based positioning comprising:
transmitting, by at least one transmitter device, a first signal fragment,
receiving, by at least one transceiver device, the first signal fragment from the transmitter device,
measuring, by the transceiver device, a phase of the first signal fragment,
transmitting, by the transceiver device, a second signal fragment with a phase having a predetermined phase relationship with the measured phase of the first signal fragment,
receiving, by at least one target device, the first signal fragment from the transmitter device,
measuring, by the target device, the phase of the first signal fragment, receiving, by the target device, the second signal fragment from the transceiver device,
measuring, by the target device, the phase of the second signal fragment,
calculating, by at least one processing unit, a phase difference between the phase of the first signal fragment and the phase of the second signal fragment as measured by the target device, and
estimating, by the processing unit, position information of the target device based on the calculated phase difference.
